(19) United States
(12) Patent Application Publication
(10) Pub. No.: US 2025/0267768 A1
(43) Pub. Date: Aug. 21, 2025

(54) INDOOR SELF-REGULATING ELECTRIC HEATING SYSTEM BASED ON CARBON-BASED ELECTRIC HEATING COATING

(71) Applicant: Zhengzhou University, Zhengzhou City (CN)

(72) Inventor: Xianglin CHENG, Zhengzhou City (CN)

(21) Appl. No.: 19/056,079

(22) Filed: Feb. 18, 2025

(30) Foreign Application Priority Data
Feb. 19, 2024 (CN) 202410183830.6

(51) Int. Cl. H05B 1/02

(52) U.S. Cl. CPC H05B 1/0277; H05B 2203/013

(57) ABSTRACT

An indoor self-regulating electric heating system based on a carbon-based electric heating coating is provided, including a heating part, where the heating part includes a wall heating coating, conductive copper strips, and an external circuit; the wall heating coating is a film formed by applying a carbon-based electric heating coating. This application adopts the indoor self-regulating electric heating system based on a carbon-based electric heating coating, where the heating coating is firmly bonded to the wall and has good durability, with a lifespan being consistent with that of the wall, thus solving the durability issue of the heating coating application. The heating coating is thin, heats evenly, and ensures the safe operation of the system.

### CROSS REFERENCE TO RELATED APPLICATION

This patent application claims the benefit and priority of Chinese Patent Application No. 2024101838306, filed with the China National Intellectual Property Administration on Feb. 19, 2024, the disclosure of which is incorporated by reference herein in its entirety as part of the present application.

### TECHNICAL FIELD

The present disclosure relates to the technical field of self-regulating electric heating, and in particular, to an indoor self-regulating electric heating system based on a carbon-based electric heating coating.

### BACKGROUND

With the improvement of people's living standards, in southern regions where winter heating needs are increasing and northern regions where municipal heating networks are not covered, the demand for heating has become more pronounced. Developing flexible, diverse, economical, and energy-saving heating methods that are suitable for local conditions has become a preferred solution. The development of green, clean, safe, efficient, and practically applicable electric heating methods is a major direction for the future of heating.

Electric heating coatings are a new type of environmentally friendly functional coatings with promising development prospects. They have high energy conversion rates and are easy to use, applicable in civil heating, industrial and agricultural heating, and other areas, with a wide range of applications. Developing a heating system based on electric heating coatings that has superior performance, adjustable and controllable temperature, and energy-saving features, and can operate automatically for a long time is still one of the main directions for the development of urban and rural heating in winter.

### SUMMARY

An objective of the present disclosure is to provide an indoor self-regulating electric heating system based on a carbon-based electric heating coating, where the heating coating is firmly bonded to the wall and has good durability, with a lifespan being consistent with that of the wall, thus solving the durability issue of the heating coating application. The heating coating is thin, heats evenly, and ensures the safe operation of the system.

To achieve the above objective, the present disclosure provides an indoor self-regulating electric heating system based on a carbon-based electric heating coating, including a heating part and a circuit control part, where the heating part includes a wall heating coating, conductive copper strips, an external circuit, a transformer, and a control system; the wall heating coating is a film formed by applying a carbon-based electric heating coating; the carbon-based electric heating coating includes: a water-based emulsion as a binder (5%-20%), and 1-10% of carbon fiber (specifications of 2 mm and 50 μm), 1-10% of graphene, 1-10% of carbon nanotubes, and 1-20% of conductive carbon black as an electrically conductive material, 5-20% of a filler, and water and additives (a dispersant, a thickener, a defoamer, and a leveling agent) as a balance.

Preferably, a preparation process involves first adding water and the dispersant into a high-speed dispersion tank, stirring evenly, then adding the filler and dispersing evenly, further adding graphene, carbon nanotubes, and conductive carbon black to form a mixture, and then stirring the mixture at a high speed of 2000-3000 rpm; after even dispersing, grinding the mixture with a sand mill to a particle size of less than or equal to 30 μm, then adding carbon fiber and dispersing evenly, and further adding the binder, defoamer, and leveling agent.

Preferably, the circuit control part includes a Bluetooth controller, a solid-state relay, a power supply soft starter, a temperature controller, and a transformer.

Preferably, a wall for the carbon-based electric heating coating first undergoes pretreatment to produce thermal insulation and obtain an insulating layer, where the conductive copper strips are attached parallel to the wall as conductive electrodes at intervals of 40-60 cm, and the conductive copper strips are connected to an output wire of the transformer.

Therefore, the present disclosure adopts the aforementioned indoor self-regulating electric heating system based on a carbon-based electric heating coating, where the heating coating is firmly bonded to the wall and has good durability, with a lifespan being consistent with that of the wall, thus solving the durability issue of the heating coating application. The heating coating is thin, heats evenly, and ensures the safe operation of the system.

The technical solutions of the present disclosure will be further described in detail below with reference to drawings and embodiments.

### BRIEF DESCRIPTION OF THE DRAWINGS

FIG. 1 is an overall schematic diagram of an indoor self-regulating electric heating system based on a carbon-based electric heating coating according to an embodiment of the present disclosure; and

FIG. 2 is an overall framework diagram of an indoor self-regulating electric heating system based on a carbon-based electric heating coating according to an embodiment of the present disclosure.

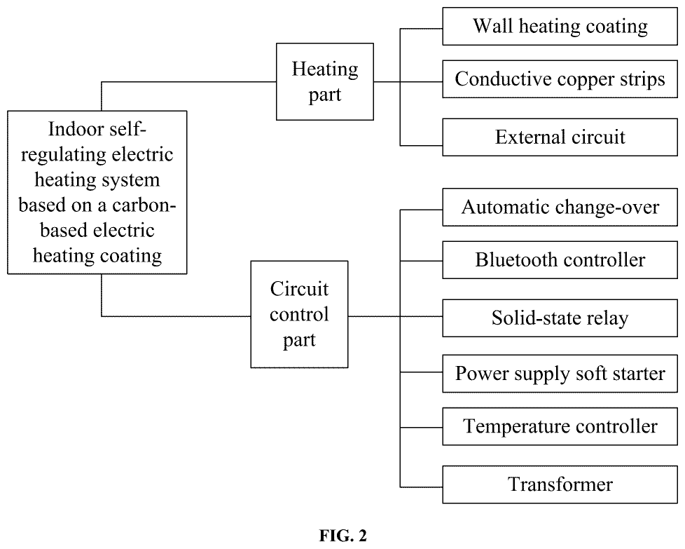

### DETAILED DESCRIPTION OF THE EMBODIMENTS

For simplicity and clarity, not all features of an actual implementation are described in the specification. However, it should be understood that many implementation-specific decisions must be made in the development of any such practical embodiment in order to achieve the developer's specific goals, such as compliance with those constraints associated with the system and business, and these restrictions may vary from implementation to implementation. Furthermore, it should also be understood that, while development work may be very complex and time consuming, such development work would be a routine undertaking for those skilled in the art having the benefit of the present disclosure.

Here, it should also be noted that, to avoid obscuring the present disclosure due to unnecessary details, only the device structure and/or processing steps closely related to the solution according to the present disclosure are shown in the accompanying drawings, and other details not greatly related to the present disclosure are omitted. The technical solutions of the present disclosure will be further described below with reference to the drawings and embodiments.

### Embodiment 1

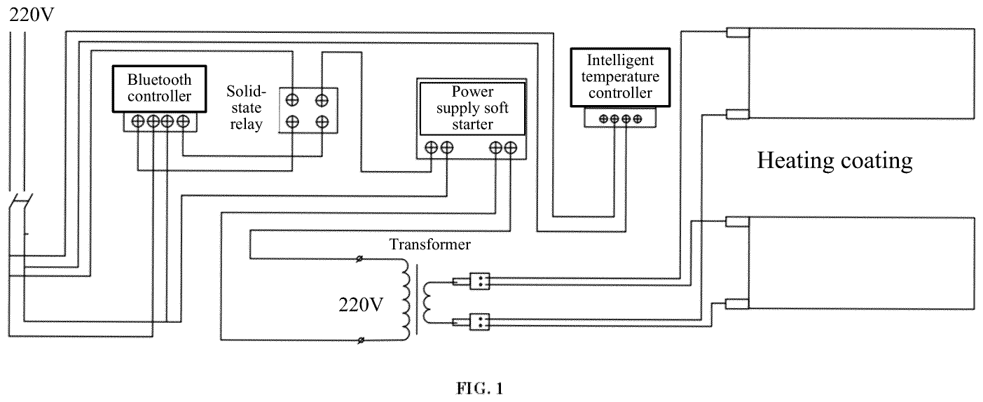

The present disclosure provides an indoor self-regulating electric heating system based on a carbon-based electric heating coating. As shown in FIG. 1, the system includes a heating part and a circuit control part, where the heating part includes a wall heating coating, conductive copper strips, an external circuit, a transformer, and a control system; the wall heating coating is a film formed by applying a carbon-based electric heating coating.

The carbon-based electric heating coating includes: a water-based emulsion as a binder (5%-20%), and 1-10% of carbon fiber (specifications of 2 mm and 50 μm), 1-10% of graphene, 1-10% of carbon nanotubes, and 1-20% of conductive carbon black as an electrically conductive material, 5-20% of a filler, and water and additives (a dispersant, a thickener, a defoamer, and a leveling agent) as a balance.

A preparation process involves first adding water and the dispersant into a high-speed dispersion tank, stirring evenly, then adding the filler and dispersing evenly, further adding graphene, carbon nanotubes, and conductive carbon black to form a mixture, and then stirring the mixture at a high speed of 2000-3000 rpm; after even dispersing, grinding the mixture with a sand mill to a particle size of less than or equal to 30 μm, then adding carbon fiber and dispersing evenly, and further adding the binder, defoamer, and leveling agent.

The circuit control part includes a Bluetooth controller, a solid-state relay, a power supply soft starter, a temperature controller, and a transformer.

A wall for the carbon-based electric heating coating first undergoes pretreatment to produce thermal insulation and obtain an insulating layer, where the conductive copper strips are attached parallel to the wall as conductive electrodes at intervals of 40-60 cm, and the conductive copper strips are connected to an output wire of the transformer.

The input voltage of the transformer is 220V mains voltage, and the output is a safe voltage of 16V-36V, addressing the safety issues of the heating coating in practical applications. The temperature controller is wirelessly connected to the Bluetooth controller of the circuit control system, and automatically cuts off when a set temperature is reached and starts to work when the temperature falls below a set temperature. The temperature controller synchronizes data with a mobile phone via Wireless Fidelity (WiFi), allowing for remote intelligent control of the temperature controller through a mobile network client.

The area of the heating coating applied to the wall occupies one-eighth to one-fourth of the actual indoor area, allowing the indoor temperature to be controlled between 18-22° C., meeting municipal heating standards. It can completely replace other heating methods.

To achieve the same temperature, the operating cost of this system is about one-third that of air conditioning and one-fifth to one-third that of wall-mounted boilers and electric oil heaters.

Due to the transition of carbon atoms in carbon material under electric heating, energy is released in the form of far-infrared radiation into the space, creating a feeling similar to sunlight, providing a strong warmth sensation. The humidity in the space is maintained at the local air humidity level, making the heating comfortable without being dry. The construction is convenient, allowing for individual heating and separate control of single rooms, with the ability to turn on and off as needed, making it economical and energy-efficient. The system has a long service life and is safe and stable.

Therefore, the present disclosure adopts the aforementioned indoor self-regulating electric heating system based on a carbon-based electric heating coating, where the heating coating is firmly bonded to the wall and has good durability, with a lifespan being consistent with that of the wall, thus solving the durability issue of the heating coating application. The heating coating is thin, heats evenly, and ensures the safe operation of the system.

Finally, it should be noted that the foregoing embodiments are only intended to describe, rather than to limit the technical solutions of the present disclosure. Although the present disclosure is described in detail with reference to the preferred embodiments, a person of ordinary skill in the art should understand that modifications or equivalent replacements may be made to the technical solutions of the present disclosure without departing from the spirit and scope of the technical solutions of the present disclosure.

What is claimed is:

1. An indoor self-regulating electric heating system based on a carbon-based electric heating coating, comprising a heating part and a circuit control part, wherein the heating part comprises a wall heating coating, conductive copper strips, an external circuit, a transformer, and a control system; the wall heating coating is a film formed by applying a carbon-based electric heating coating; the carbon-based electric heating coating comprises the following components: a water-based emulsion as a binder (5%-20%), and 1-10% of carbon fiber (specifications of 2 mm and 50 μm), 1-10% of graphene, 1-10% of carbon nanotubes, and 1-20% of conductive carbon black as an electrically conductive material, 5-20% of a filler, and water and additives (a dispersant, a thickener, a defoamer, and a leveling agent) as a balance, wherein the components are subjected to high speed stirring and even dispersing to obtain the carbon-based electric heating coating.

2. The indoor self-regulating electric heating system based on a carbon-based electric heating coating according to claim 1, wherein a preparation process of the carbon-based electric heating coating comprises: first adding water and the dispersant into a high-speed dispersion tank, stirring evenly, then adding the filler and dispersing evenly, further adding graphene, carbon nanotubes, and conductive carbon black to form a mixture, and then stirring the mixture at a high speed of 2000-3000 rpm; and after even dispersing, grinding the mixture with a sand mill to a particle size of less than or equal to 30 μm, then adding carbon fiber and dispersing evenly, and further adding the binder, the defoamer, and the leveling agent.

3. The indoor self-regulating electric heating system based on a carbon-based electric heating coating according to claim 1, wherein the circuit control part comprises a Bluetooth controller, a solid-state relay, a power supply soft starter, a temperature controller, and a transformer.

4. The indoor self-regulating electric heating system based on a carbon-based electric heating coating according to claim 1, wherein a wall for the carbon-based electric heating coating first undergoes pretreatment to produce thermal insulation and obtain an insulating layer; the conductive copper strips are attached parallel to the wall as conductive electrodes at intervals of 40-60 cm, and the conductive copper strips are connected to an output wire of the transformer.

5. The indoor self-regulating electric heating system based on a carbon-based electric heating coating according to claim 1, wherein an input voltage of the transformer is 220V mains voltage, and an output of the transformer is a safe voltage of 16V-36V; the temperature controller is wirelessly connected to a Bluetooth controller of a circuit control system, and automatically cuts off when a set temperature is reached and starts to work when temperature falls below a set temperature; the temperature controller synchronizes data with a mobile phone via Wireless Fidelity (WiFi), allowing for remote intelligent control of the temperature controller through a mobile network client.
